(19) United States
(12) Patent Application Publication
(10) Pub. No.: US 2017/0351722 A1
(43) Pub. Date: Dec. 7, 2017

(54) METHOD AND APPARATUS FOR REAL-TIME BIG DATA PROCESSING AND DISTRIBUTION BASED ON DATA SPECIFICATIONS

(71) Applicant: ELECTRONICS AND TELECOMMUNICATIONS RESEARCH INSTITUTE, Daejeon (KR)

(72) Inventors: Su-Wook HA, Daejeon (KR); Seung-Yun LEE, Daejeon (KR); Min-Kyo N, Daejeon (KR)

(73) Assignee: ELECTRONICS AND TELECOMMUNICATIONS RESEARCH INSTITUTE, Daejeon (KR)

(21) Appl. No.: 15/607,869

(22) Filed: May 30, 2017

(30) Foreign Application Priority Data
Jun. 2, 2016 (KR) 10-2016-0068992
May 8, 2017 (KR) 10-2017-0057443

(51) Int. Cl. G06F 17/30; G06F 3/0482

(52) U.S. Cl. CPC G06F 17/30336; G06F 17/30522; G06F 3/0482; G06F 17/30082; G06F 17/30126

(57) ABSTRACT

Disclosed herein are a method and apparatus for real-time processing and distribution of big data based on data specifications. An apparatus for providing big data may provide real-time processing and distribution of big data based on data specifications. The apparatus manages data specifications and receives a request for processing of a data specification from a big-data consumer device. In response to the request for processing of the data specification, the apparatus generates processed data by performing processing using the data specification and sends the processed data to the big-data consumer device.

### CROSS REFERENCE TO RELATED APPLICATIONS

This application claims the benefit of Korean Patent Application No. 10-2016-0068992, filed Jun. 2, 2016, and No. 10-2017-0057443, filed May 8, 2017, which are hereby incorporated by reference in their entirety into this application.

### BACKGROUND OF THE INVENTION

### 1. Technical Field

The following embodiments relates generally to the provision of big data, and more particularly to a method and apparatus for real-time processing and distribution of big data based on data specifications.

### 2. Description of the Related Art

As big data are becoming useful in various fields, big data service providers collect various data from individuals, institutions, SNSs, sensors, and the like in order to make good use of the collected data. Also, it is becoming more common for data users to search for and purchase desired data through data markets.

In order to manage a data market for the distribution of big data, data sellers must possess various kinds of data for meeting the requirements of different data users. Also, when storing various kinds of data, it is necessary to consider the object of analysis, the method of transferring data and data formats depending on a user's system environment and the like.

Generally, when data users make use of big data, the collected or purchased data pass a preprocessing process. Through the preprocessing process, identical data may be changed to data formats of various types depending on an internal system or a service environment.

Such a preprocessing process is commonly configured with simple and repetitive tasks. Accordingly, the preprocessing process is characterized in that it does not require high computing performance.

Also, a data market is managed in such a way that data sellers release their data using catalogs and data users search catalogs and download data found by searching the catalogs. Accordingly, in order to satisfy the requirements of data consumers, data sellers must first classify and process data to sell and must store the classified and processed data in large-scale data repositories. Such classification, processing, and storage of data incur high repository management expenses.

In order to more effectively respond to this, the following embodiments disclose a method, apparatus, and system for helping in the processing and distribution of data in real time based on data possessed by data sellers or data that can be collected by data sellers.

In order to construct a system for real-time processing and distribution of big data based on data specifications, data sellers must be capable of developing various kinds of data specifications based on data already possessed by themselves or data that can be collected in real time and of registering the developed data specifications in the system so that the data satisfy the demands of data users.

With regard to a system and method for trading big data, Korean Patent Application Publication No. 2015-0071737 has been disclosed.

### SUMMARY OF THE INVENTION

An embodiment may provide an apparatus and method that enable a big-data seller, who intends to distribute data by managing a data market in a big data environment, to write, in advance, data specifications that can be processed based on data possessed by the big-data seller or on data that can be collected in real time.

An embodiment may provide an apparatus and method through which previously written data specifications may be released in a data market.

An embodiment may provide an apparatus and method for processing data in real time and providing the processed data when a big-data consumer intends to select a data specification and purchase data.

An embodiment may provide an apparatus and method that enable a big-data seller to generate information about processing of various types of data in the form of a data specification based on available data.

An embodiment may provide an apparatus and method for providing data specifications to big-data consumers, whereby various types of data may be provided using a minimum size of repository without the need to store or manage all of the various types of data.

An embodiment may provide an apparatus and method that enable big-data consumers to select and use various data that are suitable for their system environments.

An embodiment may provide an apparatus and method for reducing the expense associated with the analysis and use of data, which is incurred when big-data consumers select and use various data.

In one aspect, there is provided an apparatus for real-time processing and distribution of big data based on data specifications, which includes a data specification management unit for managing data specifications and receiving a request for processing of a data specification from a big-data consumer device; and a big-data management unit for generating processed data by performing processing using a data specification and for sending the processed data to the big-data consumer device.

The data specification management unit may include a data specification registration unit for registering the data specification, capable of being sold to the big-data consumer device, in a data specification list.

The data specification may include information about source data, a process of generating data, and a sales policy for data.

The data specification management unit may include a data usage environment configuration unit for configuring a big-data usage environment.

The big-data usage environment may include a format of the processed data to be provided to the big-data consumer device and a method through which the big-data consumer device acquires the processed data.

The data specification management unit may include a data specification search unit for supporting searching by the big-data consumer device of data specifications registered in the apparatus.

The big-data management unit may include a real-time data resource management unit for managing information about real-time data resources.

The real-time data resources may be resources that are not stored in the apparatus but are capable of being downloaded in real time in response to a request for data from the apparatus or are capable of being collected by the apparatus.

The information about real-time data resources may include data access information, collection information, and information about a form in which data are stored.

The real-time data resource management unit may collect real-time data from an external data resource provision device.

The big-data management unit may include a data specification publication unit for generating data, generated based on available data resources with intent to sell by a user of the apparatus, in a form of a data specification.

The big-data management unit may include a data policy management unit for reviewing the processed data and modifying the processed data when modification of the processed data is required.

The big-data management unit may include a data policy management unit for controlling write permissions and read permissions for the processed data, and personal information included in data when the processed data in a form of a virtualized database are sent to the big-data consumer device.

The big-data management unit may include a data-processing unit for acquiring data stored in the apparatus and real-time data, provided from an external device in real time, based on data generation information in the data specification.

The big-data management unit may include a data-processing unit for generating the processed data by performing processing using the data specification.

The data-processing unit may process data in a format selected by the big-data consumer device depending on a configuration of a big-data usage environment.

The big-data management unit may include a stored data map management unit for managing positions in a data repository of the apparatus, at which data stored in the apparatus are located.

The data specification may include a product catalog section, a user selection section, and a data generation information section.

The user selection section may provide a range of data that the big-data consumer device intends to purchase and information for setting a method of using the data.

The data generation information section may provide information for generating data based on information selected by a data provider and information selected by the big-data consumer device.

In another aspect, there is provided a method for providing data, which includes receiving a request for processing of a data specification from a big-data consumer device; generating processed data by performing processing using the data specification; and sending the processed data to the big-data consumer device.

The processed data may be processed in a format selected depending on a configuration of a big-data usage environment.

In a further aspect, there is provided a method for registering a data specification, which includes generating processed data by performing processing of data; generating a data specification based on a processing history of the processed data; and registering the data specification in a data specification list, wherein the data include real-time data collected in real time.

Additionally, other methods, devices, and systems for implementing the present invention and a computer-readable recording medium for recording a computer program for implementing the above-described methods are further provided.

### BRIEF DESCRIPTION OF THE DRAWINGS

The above and other objects, features and advantages of the present invention will be more clearly understood from the following detailed description taken in conjunction with the accompanying drawings, in which:

FIG. 1 shows a system for providing real-time processing and distribution of big data based on data specifications according to an embodiment;

FIG. 2 shows the configuration of an apparatus for providing big data according to an embodiment;

FIG. 3 shows the configuration of a data specification according to an example;

FIG. 4 shows information about workflow of a data specification according to an example;

FIG. 5 is a flowchart of a method for providing data according to an embodiment;

FIG. 6 is a flowchart of a method for generating a data specification according to an embodiment; and

FIG. 7 illustrates an electronic device for implementing an apparatus for providing big data according to an embodiment.

### DESCRIPTION OF THE PREFERRED EMBODIMENTS

Specific embodiments will be described in detail below with reference to the attached drawings. These embodiments are described in sufficient detail to enable those skilled in the art to practice the present invention. It should be understood that the embodiments differ from each other, but the embodiments do not need to be exclusive of each other. For example, a particular feature, structure, or characteristic described herein in connection with one embodiment may be implemented in another embodiment without departing from the spirit or scope of the present invention. Also, it should be understood that the location or arrangement of individual elements in the disclosed embodiments may be changed without departing from the spirit or scope of the present invention. Therefore, the following detailed description is not to be taken in a limiting sense, and if appropriately interpreted, the scope of the exemplary embodiments is limited only by the appended claims, along with the full range of equivalents to which the claims are entitled.

The same reference numerals are used to designate the same or similar elements throughout the drawings. The shapes, sizes, etc. of components in the drawings may be exaggerated to make the description clear.

The terms used herein are for the purpose of describing particular embodiments only and are not intended to limit the present invention. As used herein, the singular forms are intended to include the plural forms as well, unless the context clearly indicates otherwise. It will be further understood that the terms “comprises,” “comprising,”, “includes” and/or “including,” when used herein, specify the presence of stated features, integers, steps, operations, elements, and/or components, but do not preclude the presence or addition of one or more other features, integers, steps, operations, elements, components, and/or groups thereof. It will be understood that when an element is referred to as being “connected” or “coupled” to another element, it can be directly connected or coupled to the other element, or intervening elements may be present.

It will be understood that, although the terms “first,” “second,” etc. may be used herein to describe various elements, these elements should not be limited by these terms. These terms are only used to distinguish one element from another element. For instance, a first element discussed below could be termed a second element without departing from the teachings of the present invention. Similarly, the second element could also be termed the first element.

Also, element modules described in the embodiments of the present invention are independently shown in order to indicate different characteristic functions, but this does not mean that each of the element modules is formed of a separate piece of hardware or software. That is, element modules are arranged and included for convenience of description, and at least two of the element units may form one element unit, or one element may be divided into multiple element units and the multiple element units may perform respective functions. An embodiment into which the elements are integrated or an embodiment from which some elements are removed is included in the scope of the present invention, as long as it does not depart from the essence of the present invention.

Also, in the present invention, some elements are not essential elements for performing essential functions, but may be optional elements for improving only performance. The present invention may be implemented using only essential elements for implementing the essence of the present invention, excluding elements used to improve only performance, and a structure including only essential elements, excluding optional elements used only to improve performance, is included in the scope of the present invention.

Hereinafter, embodiments of the present invention are described with reference to the accompanying drawings in order to describe the present invention in detail so that those having ordinary knowledge in the technical field to which the present invention pertains can easily practice the present invention. In the following description of the present invention, detailed descriptions of known functions and configurations which are deemed to make the gist of the present invention obscure will be omitted.

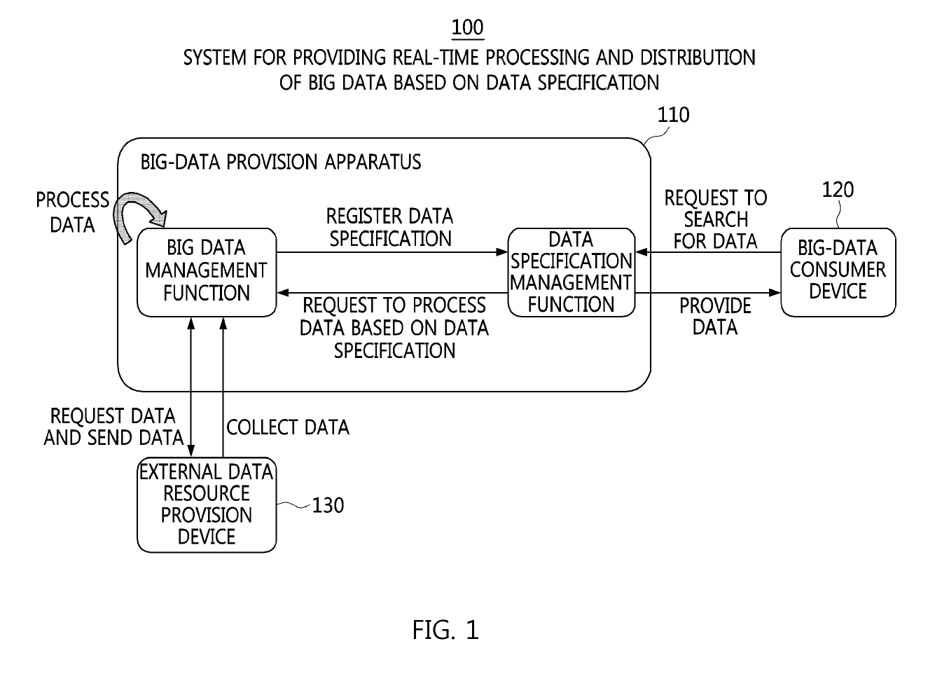

FIG. 1 shows a system for providing real-time processing and distribution of big data based on data specifications according to an embodiment.

The system 100 for providing real-time processing and distribution of big data based on data specifications may include a big-data provision apparatus 110, a big-data consumer device 120, and an external data resource provision device 130.

The big-data provision apparatus 110 may provide real-time processing and distribution of big data based on data specifications.

The big-data provision apparatus 110 may be a system for processing big data in real time based on data specifications and a system for distributing big data in real time.

The big-data consumer device 120 may be used by big-data consumers.

The big-data consumer device 120 may search for information about data specifications registered in the big-data provision apparatus 110. A big-data consumer may select a specification of data that the big-data consumer wants to purchase from among the found data specifications. The big-data consumer device 120 may request data of the selected data specification from the big-data provision apparatus 110.

The big-data provision apparatus 110 may process data based on the data specification selected by the big-data consumer device 120. The big-data provision apparatus 110 may provide the processed data to the big-data consumer device 120.

Here, the data may be data possessed by the big-data provision apparatus 110 or data in the external data resource provision device 130.

The big-data provision apparatus 110 may collect real-time data from the external data resource provision device 130. The big-data provision apparatus 110 may request data in real time from the external data resource provision device 130, and may receive data, sent from the external data resource provision device 130, in real time.

As described above, the big-data provision apparatus 110 may include a data specification management function and a big data management function.

The data specification management function may perform tasks that include 1) registration of a data specification, 2) retrieval of data requested by the big-data consumer device 120, 3) reception of a request for data from the big-data consumer device 120, 4) provision of data to the big-data consumer device 120, and the like, and may send a request for processing of data based on a data specification to the big data management function.

The big data management function may perform tasks that include 1) processing of data, 2) requesting data from the external data resource provision device 130, 3) reception of data from the external data resource provision device 130, 4) collecting data from the external data resource provision device 130, and the like.

Hereinafter, detailed functions and a processing process of the system 100 for providing real-time processing and distribution of big data based on data specifications and the configuration of information in the system 100 according to embodiments will be described in detail with reference to the accompanying drawings.

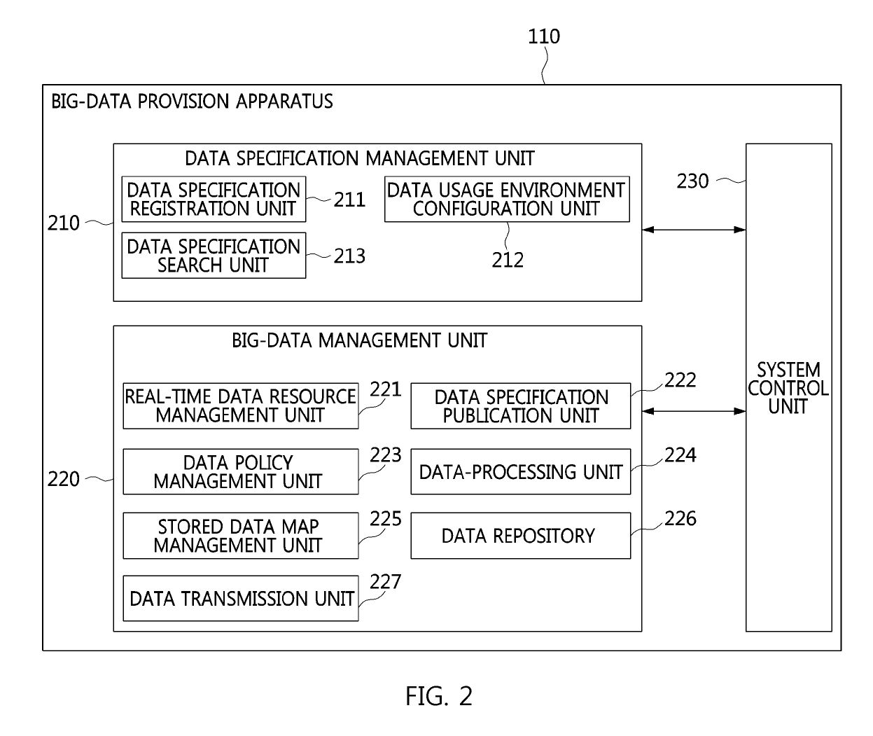

FIG. 2 shows the configuration of an apparatus for providing big data according to an embodiment.

The big-data provision apparatus 110 may support real-time processing and distribution of big data based on data specifications.

The big-data provision apparatus 110 may include a data specification management unit 210, a big-data management unit 220, and a system control unit 230.

The data specification management unit 210 may manage data specifications.

The data specification management unit 210 may receive a request for processing of a data specification from the big-data consumer device 120.

The big-data management unit 220 may perform processing using a data specification, thereby generating processed data.

The big-data management unit 220 may send the processed data to the big-data consumer device.

The data specification management unit 210 may include a data specification registration unit 211, a data usage environment configuration unit 212, and a data specification search unit 213.

The data specification registration unit 211 may register a data specification that can be sold to big-data consumers or the big-data consumer device 120 in a data specification list.

When a data specification is registered in the data specification list, a sales policy for data of the data specification may be determined for the big-data consumer or the big-data consumer device 120. The data specification registration unit 211 may include the sales policy for data in information about data specifications.

The sales policy may include a selling price and the like.

The registered data specification may include 1) information about source data, 2) the process of generating data, 3) the sales policy for data, and the like.

The data usage environment configuration unit 212 may configure a big-data usage environment.

The big-data usage environment may include the format of the processed data, to be provided to the big-data consumer device 120, and the method through which the big-data consumer device 120 acquires the processed data.

The data usage environment configuration unit 212 may receive a request to configure a big-data usage environment from the big-data consumer device 120.

In response to the request to configure the big-data usage environment, the data usage environment configuration unit 212 may set the format of the processed data and the method through which the big-data consumer device 120 acquires the processed data.

For example, through the configuration of the method of acquiring data, a big-data seller may enable the big-data consumer device 120 to select one of multiple transmission methods as the transmission method for the processed data.

For example, the data usage environment configuration unit 212 may add the set method of receiving data to the data specification.

The data specification search unit 213 may support searching of registered data specifications by the big-data consumer device 120.

The data specification search unit 213 may receive a request for information about registered data specifications from the big-data consumer device 120. When it receives the request for information about registered data specifications, the data specification search unit 213 may send information about registered data specifications to the big-data consumer device 120.

The big-data management unit 220 may include a real-time data resource management unit 221, a data specification publication unit 222, a data policy management unit 223, a data-processing unit 224, a stored data map management unit 225, a data repository 226, and a data transmission unit 227.

The real-time data resource management unit 221 may manage information about real-time data resources. The real-time data resources may be resources that are not stored in the data repository 226 but can be downloaded in real time in response to a request from the big-data provision apparatus 110, or can be collected by the big-data provision apparatus 110.

The information about the real-time data resources may include 1) data access information, 2) collection tool information, 3) information about the form in which data are stored, and the like.

The real-time data resource management unit 221 may collect real-time data from the external data resource provision device 130. The real-time data resource management unit 221 may request data from the external data resource provision device 130 in real time, and may receive data, sent from the external data resource provision device 130, in real time.

The data specification publication unit 222 may generate data, generated based on the available data resources with the intent to sell the same by the user of the big-data provision apparatus 110, in the form of a data specification. The data specification publication unit 222 may register the data specification in the data specification registration unit 211.

The data policy management unit 223 may review the processed data, and may modify the processed data when the modification of the processed data is required.

The data policy management unit 223 may control write permissions and read permissions for the processed data and/or personal information included in the data when the processed data, in the form of a virtualized database, are sent to the big-data consumer device 120.

The data-processing unit 224 may acquire data stored in the big-data provision apparatus 110 and real-time data provided in real time from the external data resource provision device 130, based on the data generation information in the data specification.

The data-processing unit 224 may request data from the stored data map management unit 225 and the real-time data resource management unit 221 based on the data generation information in the data specification. Here, the data may include stored data and real-time data.

For example, the data-processing unit 224 may request data from the stored data map management unit 225 when the data generation information indicates that data stored in the big-data provision apparatus 110 are required.

For example, the data-processing unit 224 may request real-time data from the real-time data resource management unit 221 when the data generation information indicates that a real-time data resource is required.

The data-processing unit 224 performs processing using a data specification, thereby generating processed data. The data-processing unit 224 may process data in the form selected by a big-data consumer or the big-data consumer device 120 depending on the configuration of the big-data usage environment.

The data-processing unit 224 may generate processed data by processing prepared data based on a data specification. The prepared data may include data stored in the big-data provision apparatus 110, which are provided by the stored data map management unit 225, and real-time data provided by the real-time data resource management unit 221.

The data-processing unit 224 may temporarily store the processed data in the data repository 226.

The stored data map management unit 225 may manage information about positions in the data repository 226, at which the data stored in the big-data provision apparatus 110 are located.

The data repository 226 may physically store the data stored in the big-data provision apparatus 110 or processed data to be sent to the outside.

The data transmission unit 227 may send the processed data to the big-data consumer device 120.

The system control unit 230 may manage and control a processing process for the interaction between the data specification management unit 210 and the big-data management unit 220. Also, the system control unit 230 may process the interaction between the big-data provision apparatus 110 and the big-data consumer device 120.

According to an embodiment, at least some of the data specification management unit 210, the big-data management unit 220, the system control unit 230, the data specification registration unit 211, the data usage environment configuration unit 212, the data specification search unit 213, the real-time data resource management unit 221, the data specification publication unit 222, the data policy management unit 223, the data-processing unit 224, the stored data map management unit 225, the data repository 226, and the data transmission unit 227 may be program modules, and may communicate with external devices or systems. The program modules may be included in the big-data provision apparatus 110 as an operating system, an application module, or another kind of program module.

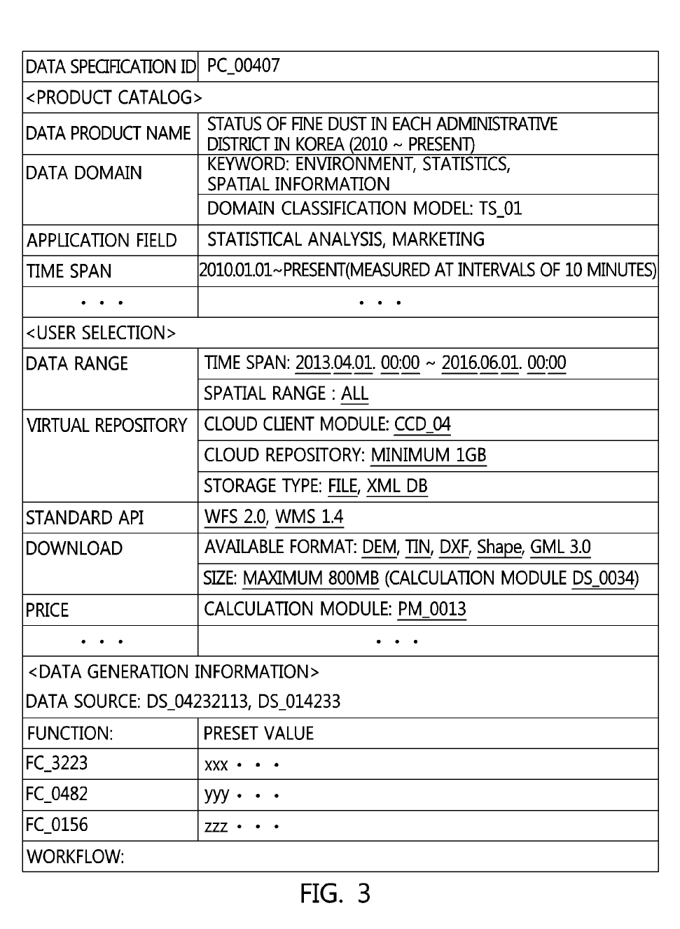

FIG. 3 shows the configuration of a data specification according to an example.

A data specification may include 1) a product catalog section, 2) a user selection section, and 3) a data generation information section.

The product catalog section may provide information through which a big-data consumer or the big-data consumer device 120 may identify a data product.

The user selection section may provide information for setting the range of data that a big-data consumer or the big-data consumer device 120 intends to purchase and the method of using the data.

The data generation information section may provide information for generating data based on information selected by a data provider and information selected by a big-data consumer or the big-data consumer device 120.

For example, the product catalog section of a data specification may include information, such as 1) a data product name, 2) a data domain 3) a data application field, 4) the time span of data, and the like.

For example, the user selection section may provide information about a method of purchasing data. The method of purchasing data may include a purchase of a portion of the data and a method of transmitting the data. The method of transmitting data may be a method of downloading the data.

In other words, the user selection section may provide information through which a big-data consumer or the big-data consumer device 120 may purchase a part of data. Also, the user selection section may provide information through which a big-data consumer or the big-data consumer device 120 may select and set one of multiple data transmission methods. For example, one of the multiple data transmission methods may be transmission using cloud storage.

The data generation information may include information about a data source that is used when data are generated and information about workflow for functions. Basically, when a data specification is selected, the values of setting variables in the data specification may be set in advance. In order to execute the workflow, the preset values of setting variables may be updated depending on a data range or a data transmission method selected by a big-data consumer or a data consumer selected by the big-data consumer device 120. The values for the update may be sent to the data-processing unit 224 of the big-data management unit 220. When the values are sent, data to be sold may be generated in real time.

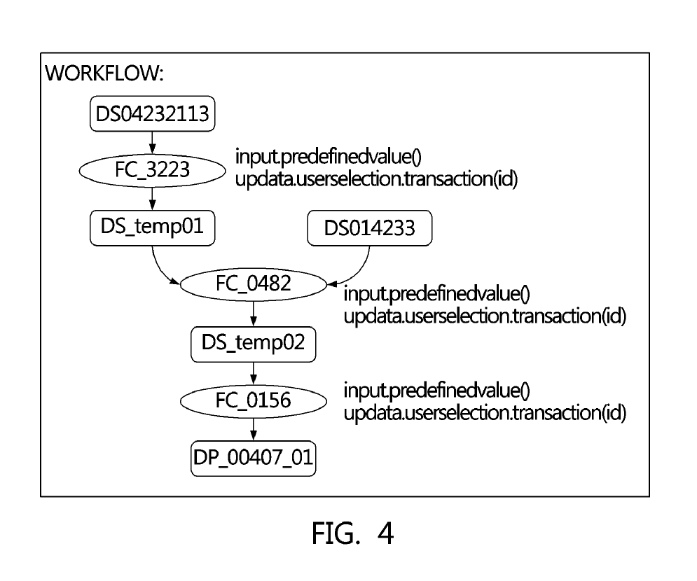

The information about workflow will be described separately with reference to FIG. 4.

FIG. 4 shows information about workflow of a data specification according to an example.

The workflow of a data specification may include multiple functions. In FIG. 4, FC_3223, FC_0482 and FC_0156 are illustrated as representative of the multiple functions.

Also, FIG. 4 illustrates a process in which the preset values of setting variables for the exemplary functions, such as FC_3223, FC_0482 and FC_0156, are updated to the values set by a big-data consumer or the big-data consumer device 120.

The input of a function may include a data specification. Also, the input of a function may further include data. Here, the data specification may be a temporary data specification output from another function. The input of the first function, among the multiple functions, may include a data specification. The input of a function that is not the first function, among the multiple functions, may include a temporary data specification.

The output of a function may be a temporary data specification or data. The output of the final function, among the multiple functions, may be data. The output of a function that is not the final function, among the multiple functions, may be a temporary data specification.

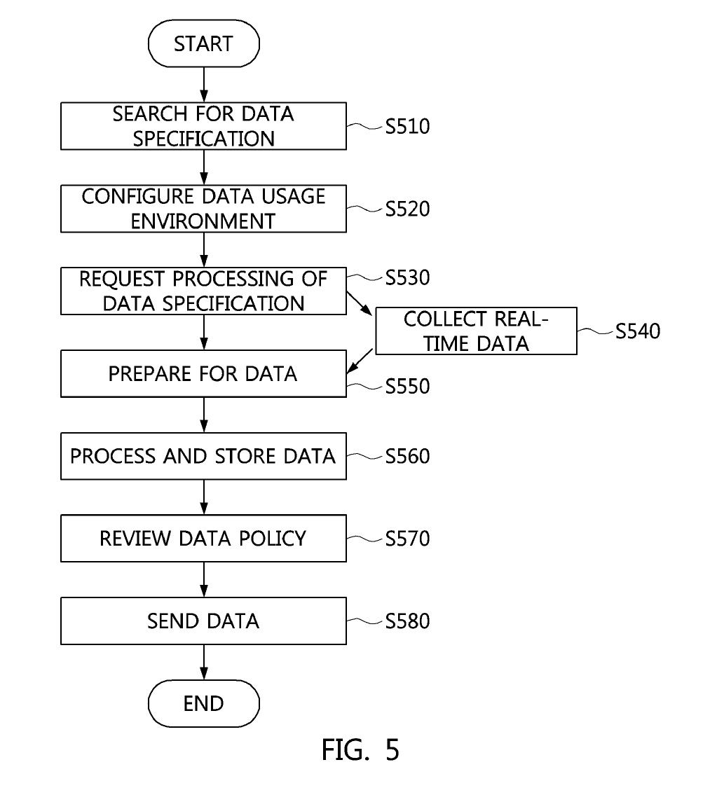

FIG. 5 is a flowchart of a method for providing data according to an embodiment.

Through steps 510, 520, 530, 540, 550, 560, 570 and 580, real-time processing and distribution of big data based on data specifications may be provided.

At step 510, a big-data consumer device 120 may search for information about data specifications registered in the big-data provision apparatus 110.

The big-data consumer device 120 may send a request for information about registered data specifications to the data specification search unit 213. The data specification search unit 213 may receive the request for information about registered data specifications from the big-data consumer device 120.

When it receives the request for information about registered data specifications, the data specification search unit 213 may send information about registered data specifications to the big-data consumer device 120. The big-data consumer device 120 may receive the information about registered data specifications from the data specification search unit 213.

A big-data consumer or the big-data consumer device 120 may select desired data using the information about registered data specifications.

At step 520, the big-data consumer device 120 may configure a big-data usage environment.

A big-data consumer or the big-data consumer device 120 may select one of multiple formats provided by the big-data provision apparatus 110 as the format of processed data. Also, the big-data consumer or the big-data consumer device 120 may select one of transmission methods provided by the big-data provision apparatus 110 as a method for transmitting processed data.

The big-data consumer device 120 may send a request to configure a big-data usage environment to the data usage environment configuration unit 212. The data usage environment configuration unit 212 may receive the request to configure the big-data usage environment from the big-data consumer device 120.

In response to the request to configure the big-data usage environment, the data usage environment configuration unit 212 may select the format of processed data and a method through which the big-data consumer device 120 acquires processed data.

At step 530, the big-data consumer device 120 may send a request for processing of a data specification to the data specification management unit 210. The data specification management unit 210 may receive the request for processing of a data specification from the big-data consumer device 120.

When it receives the request for processing of a data specification, the data specification management unit 210 may send the data specification to the data-processing unit 224 of the big-data management unit 220 through the system control unit 230, and may send a request for processing of the data specification to the data-processing unit 224.

When a real-time data resource is required for processing of the data specification, the data-processing unit 224 may send a request for real-time data to the real-time data resource management unit 221. The real-time data resource management unit 221 may receive the request for real-time data from the data-processing unit 224.

After sending the request for real-time data to the real-time data resource management unit 221, the data-processing unit 224 may stand by until preparation of real-time data is completed.

At step 540, the real-time data resource management unit 221 may collect real-time data from an external data resource provision device 130.

At step 550, the data-processing unit 224 may detect that preparation of data to be used for processing of the data specification is completed. The prepared data may include data stored in the big-data provision apparatus 110, which are provided by the stored data map management unit 225, and real-time data provided by the real-time data resource management unit 221.

At step 560, the data-processing unit 224 may generate processed data by processing the data prepared based on the data specification.

The data-processing unit 224 may temporarily store the processed data in the data repository 226.

At step 570, the data policy management unit 223 may review the processed data and modify the processed data when modification of the processed data is required.

At step 580, the data transmission unit 227 may send the processed data to the big-data consumer device 120.

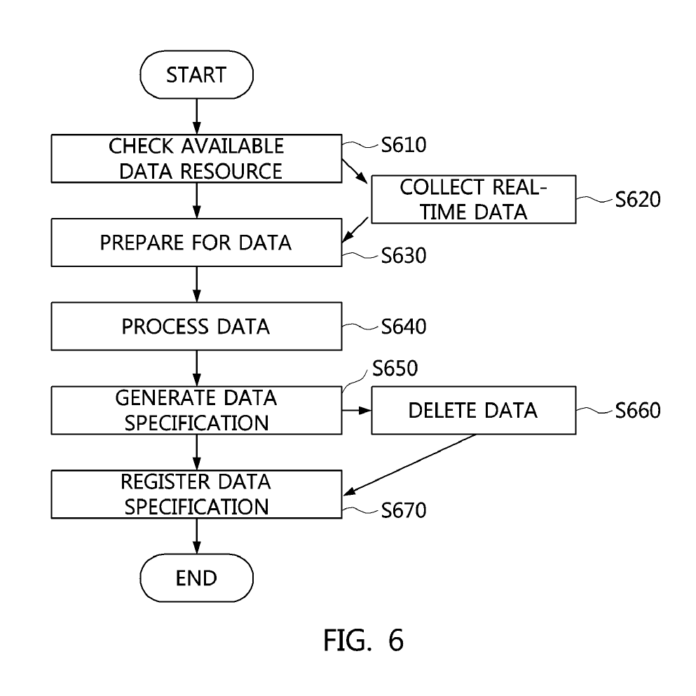

FIG. 6 is a flowchart of a method for generating a data specification according to an embodiment.

Through steps 610, 620, 630, 640, 650, 660 and 670, a data specification for real-time processing and distribution of big data may be generated.

At step 610, the data specification publication unit 222 may provide information about available data resources to the big-data consumer device 120.

The big-data consumer device 120 checks the available data resources, and may send a request to collect real-time data to the data-processing unit 224 if necessary. The data-processing unit 224 may receive the request to collect real-time data from the big-data consumer device 120.

The real-time data may be data collected in real time when a data specification is generated.

The data-processing unit 224 may send the request to collect real-time data to the real-time data resource management unit 221. The real-time data resource management unit 221 may receive the request to collect real-time data from the data-processing unit 224.

After sending the request to collect real-time data to the real-time data resource management unit 221, the data-processing unit 224 may stand by until preparation of real-time data is completed.

At step 620, the real-time data resource management unit 221 may collect real-time data from an external data resource provision device 130.

At step 630, the data-processing unit 224 may detect that preparation of data for generating a data specification is completed. The prepared data may include data stored in the big-data provision apparatus 110, which are provided by the stored data map management unit 225, and real-time data provided by the real-time data resource management unit 221.

At step 640, the data-processing unit 224 may process the prepared data. The data-processing unit 224 may generate processed data by processing the prepared data. When processing data, a data-processing function, provided by the data-processing unit 224, may be used. The processed data may be data that can be generated in real time through the data specification.

When processing of data is completed, the data specification publication unit 222 may generate a data specification at step 650 based on a processing history of the processed data.

The processed data may be selectively deleted from the big-data provision apparatus 110. At step 660, the data-processing unit 224 may delete the processed data.

At step 670, the data specification registration unit 211 may register the generated data specification in a data specification list.

When the data specification is registered in the data specification list, a sales policy for data of the data specification may be determined. Information about data specifications may include the sales policy for data of the data specifications.

Through the above-described process, a big-data seller may generate a data specification and register the generated data specification in the big-data provision apparatus 110.

A big-data consumer or the big-data consumer device 120 may search for the registered data specification, and may order data of the found data specification. The big-data provision apparatus 110 may process requested data in real time and send the processed data to the big-data consumer device 120.

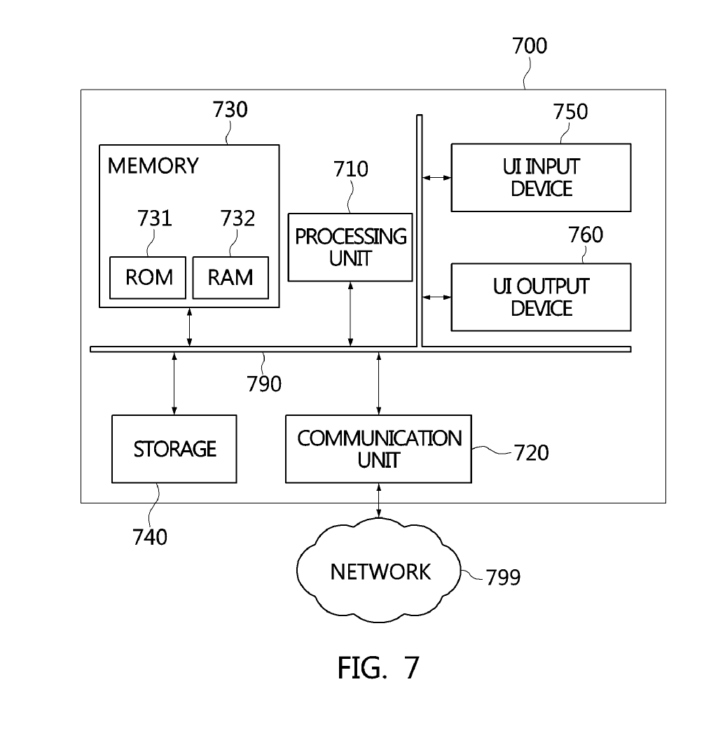

FIG. 7 illustrates an electronic device for implementing an apparatus for providing big data according to an embodiment.

The big-data provision apparatus 110 may be implemented as the electronic device 700 illustrated in FIG. 7. The electronic device 700 may be a general-purpose computer system that operates as the big-data provision apparatus 110.

As illustrated in FIG. 7, the electronic device 700 may include at least some of a processing unit 710, a communication unit 720, memory 730, storage 740 and a bus 790. The components of the electronic device 700, such as the processing unit 710, the communication unit 720, the memory 730, the storage 740, and the like, may communicate with each other via the bus 790.

The processing unit 710 may be a semiconductor device for executing processing instructions stored in the memory 730 or the storage 740. For example, the processing unit 710 may be at least one hardware processor.

The processing unit 710 may process work required for the operation of the electronic device 700. The processing unit 710 may execute the code of operations or steps of the processing unit 710 explained in the embodiments.

The processing unit 710 may perform the generation, storage, and output of information to be described in the following embodiment, and may additionally process other operations of steps performed in the electronic device 700.

The communication unit 720 may be connected with a network 799, and may receive and send data or information required for the operation of the electronic device 700. The communication unit 720 may send data to other devices and receive data from other devices via the network 799. For example, the communication unit 720 may be a network chip or port.

The memory 730 and the storage 740 may be various types of volatile or nonvolatile storage media. For example, the memory 730 may include at least one of ROM 731 and RAM 732. The storage 740 may include an internal storage medium, such as RAM, flash memory, a hard disk, or the like, and may include a removable storage medium, such as a memory card or the like.

The function or operation of the electronic device 700 may be performed when the processing unit 710 executes at least one program module. The memory 730 and/or the storage 740 may store at least one program module therein. The at least one program module may be configured to be executed by the processing unit 710.

The electronic device 700 may further include a User Interface (UI) input device 750 and a UI output device 760. The UI input device 750 may receive user input required for the operation of the electronic device 700. The UI output device 760 may output information or data depending on the operation of the electronic device 700.

According to the above-described embodiments, the following scenario may be illustrated as an example.

A big-data seller may possess map data, data of Social Networking Services (SNSs), data related to store information and data about floating population. Based on the possessed data, the big-data seller may write information about a local business district and preferences in the form of a data specification, and may then register the data specification in the big-data provision apparatus 110.

A big-data consumer may purchase information about preferences for fashion brands in a desired region during the past year such that the information is to be provided in the form of DB-APIs through the big-data provision apparatus 110.

The big-data seller may generate information desired by the big-data consumer based on a data specification using the function of real-time processing and distribution of big data based on data specifications, provided by the big-data provision apparatus 110, and may provide the generated information in the form of online APIs.

As data are provided in this manner, the big-data seller may satisfy the requirements of the big-data consumer while minimizing the capacity of a repository used for selling data. Also, the big-data consumer uses the APIs, provided for the use of data, through mashup in his or her device, thereby reducing the time and expense for data analysis.

The device described herein may be implemented using hardware components, software components, or a combination thereof. For example, the device and components described in the embodiments may be implemented using one or more general-purpose or special-purpose computers, for example, a processor, a controller, an arithmetic logic unit (ALU), a digital signal processor, a microcomputer, a field programmable array (FPA), a programmable logic unit (PLU), a microprocessor or any other device capable of responding to and executing instructions. The processing device may run an operating system (OS) and one or more software applications that run on the OS. The processing device may also access, store, manipulate, process, and create data in response to execution of the software. For convenience of understanding, the use of a single processing device is described, but those skilled in the art will understand that a processing device may comprise multiple processing elements and multiple types of processing elements. For example, a processing device may include multiple processors or a single processor and a single controller. Also, different processing configurations, such as parallel processors, are possible.

The software may include a computer program, code, instructions, or some combination thereof, and it is possible to configure processing devices or to independently or collectively instruct the processing devices to operate as desired. Software and data may be embodied permanently or temporarily in any type of machine, component, physical or virtual equipment, computer storage medium, or device, or in a propagated signal wave in order to provide instructions or data to the processing devices or to be interpreted by the processing devices. The software may also be distributed in computer systems over a network such that the software is stored and executed in a distributed manner. In particular, the software and data may be stored in one or more computer-readable recording media.

The above-described embodiments may be implemented as a program that can be executed by various computer means. In this case, the program may be recorded on a computer-readable storage medium. The computer-readable storage medium may include program instructions, data files, and data structures, either solely or in combination. Program instructions recorded on the storage medium may have been specially designed and configured for the present invention, or may be known to or available to those who have ordinary knowledge in the field of computer software. Examples of the computer-readable storage medium include all types of hardware devices specially configured to record and execute program instructions, such as magnetic media, such as a hard disk, a floppy disk, and magnetic tape, optical media, such as compact disk CD-ROM and a DVD, magneto-optical media, such as a floptical disk, ROM, RAM, and flash memory. Examples of the program instructions include machine code, such as code created by a compiler, and high-level language code executable by a computer using an interpreter. The hardware devices may be configured to operate as one or more software modules in order to perform the operation of the present invention, and vice versa.

There are provided an apparatus and method that enable a big-data seller, who intends to distribute data by managing a data market in a big data environment, to write, in advance, data specifications that can be processed based on data possessed by the big-data seller or on data that can be collected in real time.

There are provided an apparatus and method through which previously written data specifications may be released in a data market.

There are provided an apparatus and method for processing data in real time and providing the processed data when a big-data consumer intends to select a data specification and purchase data.

There are provided an apparatus and method that enable a big-data seller to generate information about processing of various types of data in the form of a data specification based on available data.

There are provided an apparatus and method in which data specifications are provided to big-data consumers, whereby various types of data may be provided using a minimum size of repository without the need to store or manage all of the various types of data.

There are provided an apparatus and method that enable big-data consumers to select and use various data that are suitable for their system environments.

There are provided an apparatus and method for reducing the expenses associated with the analysis and use of data, which is incurred when big-data consumers select and use various kinds of data.

Although the embodiments of the present invention have been disclosed for illustrative purposes, those skilled in the art will appreciate that various modifications, additions and substitutions are possible, without departing from the scope and spirit of the invention. For example, if the described techniques are performed in a different order, if the described components, such as systems, architectures, devices, and circuits, are combined or coupled with other components by a method different from the described methods, or if the described components are replaced with other components or equivalents, the results are still to be understood as falling within the scope of the present invention.

What is claimed is:

1. An apparatus for real-time processing and distribution of big data based on data specifications, comprising:
a data specification management unit for managing data specifications and receiving a request for processing of a data specification from a big-data consumer device; and
a big-data management unit for generating processed data by performing processing using a data specification and for sending the processed data to the big-data consumer device.

2. The apparatus of claim 1, wherein the data specification management unit comprises:
a data specification registration unit for registering the data specification, capable of being sold to the big-data consumer device, in a data specification list.

3. The apparatus of claim 1, wherein the data specification includes information about source data, a process of generating data, and a sales policy for data.

4. The apparatus of claim 1, wherein:
the data specification management unit comprises a data usage environment configuration unit for configuring a big-data usage environment; and
the big-data usage environment includes a format of the processed data to be provided to the big-data consumer device and a method through which the big-data consumer device acquires the processed data.

5. The apparatus of claim 1, wherein the data specification management unit comprises:
a data specification search unit for supporting searching by the big-data consumer device of data specifications registered in the apparatus.

6. The apparatus of claim 1, wherein:
the big-data management unit comprises a real-time data resource management unit for managing information about real-time data resources; and
the real-time data resources are resources that are not stored in the apparatus but are capable of being downloaded in real time in response to a request for data from the apparatus or are capable of being collected by the apparatus.

7. The apparatus of claim 6, wherein the information about real-time data resources includes data access information, collection information, and information about a form in which data are stored.

8. The apparatus of claim 6, wherein the real-time data resource management unit collects real-time data from an external data resource provision device.

9. The apparatus of claim 1, wherein the big-data management unit comprises:
a data specification publication unit for generating data, generated based on available data resources with intent to sell by a user of the apparatus, in a form of a data specification.

10. The apparatus of claim 1, wherein the big-data management unit comprises:
a data policy management unit for reviewing the processed data and modifying the processed data when modification of the processed data is required.

11. The apparatus of claim 1, wherein the big-data management unit comprises:
a data policy management unit for controlling write permissions and read permissions for the processed data, and personal information included in data when the processed data in a form of a virtualized database are sent to the big-data consumer device.

12. The apparatus of claim 1, wherein the big-data management unit comprises:
a data-processing unit for acquiring data stored in the apparatus and real-time data, provided from an external device in real time, based on data generation information in the data specification.

13. The apparatus of claim 1, wherein:
the big-data management unit comprises a data-processing unit for generating the processed data by performing processing using the data specification; and
the data-processing unit processes data in a format selected by the big-data consumer device depending on a configuration of a big-data usage environment.

14. The apparatus of claim 1, wherein the big-data management unit comprises:
a stored data map management unit for managing positions in a data repository of the apparatus, at which data stored in the apparatus are located.

15. The apparatus of claim 1, wherein the data specification includes a product catalog section, a user selection section, and a data generation information section.

16. The apparatus of claim 15, wherein the user selection section provides a range of data that the big-data consumer device intends to purchase and information for setting a method of using the data.

17. The apparatus of claim 15, wherein the data generation information section provides information for generating data based on information selected by a data provider and information selected by the big-data consumer device.

18. A method for providing data, comprising:
receiving a request for processing of a data specification from a big-data consumer device;
generating processed data by performing processing using the data specification; and
sending the processed data to the big-data consumer device.

19. The method of claim 18, wherein the processed data are processed in a format selected depending on a configuration of a big-data usage environment.

20. A method for registering a data specification, comprising:
generating processed data by performing processing of data;
generating a data specification based on a processing history of the processed data; and
registering the data specification in a data specification list,
wherein the data include real-time data collected in real time.
